(19) United States
(12) Patent Application Publication
(10) Pub. No.: US 2015/0225595 A1
(43) Pub. Date: Aug. 13, 2015

(54) SURFACE FOR VEHICLE COMPONENT AND METHOD FOR MANUFACTURING THE SAME

(71) Applicant: Hyundai Motor Company, Seoul (KR)

(72) Inventors: Dong-Jae Choi, Seoul (KR); Hyeon-Gyun Ahn, Seoul (KR)

(73) Assignee: HYUNDAI MOTOR COMPANY

(21) Appl. No.: 14/554,716

(22) Filed: Nov. 26, 2014

(30) Foreign Application Priority Data
Feb. 7, 2014 (KR) 10-2014-014284

(51) Int. Cl. C09D 133/08; B05D 1/02; B05D 3/00; B05D 1/18

(52) U.S. Cl. CPC C09D 133/08; B05D 1/18; B05D 1/02; B05D 3/007

(57) ABSTRACT

Disclosed is a surface layer for a vehicle part. In particular, the surface layer for a vehicle part includes a trivalent dark chrome plating layer; and an organic-inorganic hybrid coating layer forming a chemical bond with the plating layer, and in the organic-inorganic hybrid coating layer, an inorganic nanoceramic oxide is included in an organic synthetic resin base. Therefore, by forming a chemical bond between the trivalent dark chrome plating layer and the organic-inorganic hybrid coating layer, corrosion resistance of the surface layer may not deteriorate in high-temperature environments, thereby overcoming disadvantages of a conventional trivalent dark chrome surface layer. Also disclosed is a method for manufacturing the surface layer for a vehicle part.

### CROSS-REFERENCE TO RELATED APPLICATIONS

This application claims priority under 35 U.S.C. §119 to Korean Patent Application No. 10-2014-14284, filed on Feb. 7, 2014, in the Korean Intellectual Property Office, the entire content of which is incorporated herein by reference.

### TECHNICAL FIELD

The present invention relates to a surface layer of a vehicle part. Particularly, when the surface layer is applied on the vehicle part such as a muffler tail trim, corrosion resistance of the surface layer may not deteriorate in high-temperature environments, thereby overcoming disadvantages of conventional trivalent dark chrome surface layer. Also provided is a method of manufacturing the surface layer.

### BACKGROUND

Recently, technologies imparting various color senses to conventional exterior metal components have been developed with the sophistication of vehicles. Among other materials, stainless steel and chrome-plated components which have substantial decorativeness and anti-corrosive properties have been commonly used as metal materials.

These stainless steel or chrome plating may have advantages such as an elegant metallic appearance of themselves. However, changing the color thereof may not be simple. For example, for stainless steel, changing color may not be achieved without luster adjustments and the like. For the chrome plating, the colors may be limited to bright white to dark colors depending on the ingredients of additives.

Stainless steel or chrome plating may be used for exterior parts of a vehicle, such as a muffler tail trim. A muffler tail trim is a part located at the outer end of an exhaust system and of which appearance is exposed. Accordingly, stainless steel materials with excellent corrosion resistance have been used since decorativeness may not be required significantly. However, merchantability deterioration may occur accompanying with appearance changes within a few years due to an accelerated corrosion which is caused by condensed water, deicing salts, adsorption of exhaust and dust on the surface, and the like.

FIG. 1A is a photographic view showing an exemplary muffler tail trim made of a stainless steel material, and FIG. 1B is a photographic view showing a hexavalent black chrome-plated and top-coated muffler tail trim surface made of a stainless material in the related art. Since hexavalent chrome is a harmful material having toxicity, and recently the use of hexavalent chrome has been restricted. Accordingly, the use of trivalent chrome, particularly, trivalent dark chrome for improving the luxurious exterior of vehicles has been desired.

FIGS. 2A and 2B are photographic views of each showing a muffler tail trim surface made of a stainless steel material plated with trivalent white chrome and trivalent dark chrome, respectively. Although deterioration of corrosion resistance does not occur at low temperatures or at room temperature, discoloration may occur due to the accelerated progression of corrosion caused by deteriorating physical properties of the plating layer surface, when the vehicle part such as a muffler tail trim part is exposed to high-temperature environments, as shown in FIG. 3. In fact, small amounts of impurities such as C, S, Co, Fe and P added to obtain dark colors may chemically react with chrome-plated Cr components when trivalent dark chrome is exposed for a long period of time in high-temperature environments of 200° C. or greater, thereby causing local irregular regions on the surface. And thus, such regions may reduce the corrosion resistance.

As such, coating technologies capable of suppressing deterioration of corrosion resistance in a trivalent dark chrome layer even in high-temperature environments have been desired.

### SUMMARY OF THE INVENTION

In one aspect, the present invention provides a surface layer for a vehicle part, of which corrosion resistance may not deteriorate in high-temperature environments, thereby overcoming disadvantages of trivalent dark chrome. In particular, the surface layer may be formed by forming a chemical bond between a trivalent dark chrome plating layer and an organic-inorganic hybrid coating layer in which an inorganic nanoceramic oxide is included in an organic synthetic resin base. In another aspect, a method for manufacturing the surface layer is disclosed.

In an exemplary embodiment, a surface layer for a vehicle part may include: a trivalent dark chrome plating layer; and an organic-inorganic hybrid coating layer forming a chemical bond with the plating layer. In the organic-inorganic hybrid coating layer, an inorganic nanoceramic oxide is included in an organic synthetic resin base.

In certain exemplary embodiments, the trivalent dark chrome plating layer may be a Cr-based plating layer containing an impurity ion (M′), such as Zn, Al, Mg, Si, C, S, Co, Fe, P or a combination thereof. In other certain exemplary embodiments, the inorganic nanoceramic oxide may include a ceramic ion (M), such as Si, Ti or Zr. Particularly, the chemical bond may be an M′—O—M bond of the impurity ion (M′) and the ceramic ion (M), and the synthetic resin may be an acrylic resin.

In another exemplary embodiment, a method of manufacturing a surface layer for vehicle part may include: applying a trivalent dark chrome plating layer on a substrate; preparing an organic-inorganic composite coating solution through a sol-gel process by dispersing ceramic particles in a liquid organic coating material; forming a surface layer by applying the coating solution on the surface of the trivalent dark chrome plating layer; and curing the surface layer.

In certain exemplary embodiments, the average diameter of the ceramic particles may range from about 10 to about 50 nm. In yet certain exemplary embodiments, coating solution may be applied on the surface of the trivalent dark chrome plating layer using a spray or dipping process, and the curing may be carried out for about 15 to 30 minutes at a temperature of about 160 to about 200° C.

In certain exemplary embodiments, the substrate may be a vehicle part.

Other aspect of the present invention is disclosed infra.

### BRIEF DESCRIPTION OF DRAWINGS

The above and other aspects, features and other advantages of the present disclosure will be more clearly understood from the following detailed description taken in conjunction with the accompanying drawings, in which:

FIG. 1A is a photographic view showing a muffler tail trim made of a stainless steel material in the related art;

FIG. 1B is a photographic view showing a hexavalent black chrome-plated and top-coated muffler tail trim surface made of a stainless steel material in the related art;

FIGS. 2A and 2B are photographic views each showing a muffler tail trim surface made of a stainless steel material plated with trivalent white chrome and trivalent dark chrome, respectively, in the related art;

FIG. 3 is a photographic view showing an exemplary muffler tail trim corroded;

FIG. 4A is a photographic view showing an exemplary trivalent dark chrome plating layer at low temperatures or at a room temperature;

FIG. 4B is a photographic view showing an exemplary trivalent dark chrome plating layer at a high-temperature environment of about 200° C.;

FIG. 5 prospectively shows showing an exemplary surface layer according to an exemplary embodiment of the present invention;

FIG. 6 schematically shows an exemplary method of manufacturing an exemplary surface layer according to an exemplary embodiment of the present invention;

FIG. 7A is a photographic view showing an exemplary muffler tail trim applied with hexavalent white chrome plating in the related art;

FIGS. 7B and 7C are photographic views showing exemplary muffler tail trims applied with trivalent white chrome plating and trivalent dark chrome plating, respectively; and

FIGS. 8A and 8B are photographic views showing muffler tail trims formed with an exemplary surface layer according to an exemplary embodiment of the present invention. FIG. 8A is clear color coated, FIG. 8B is black color coated.

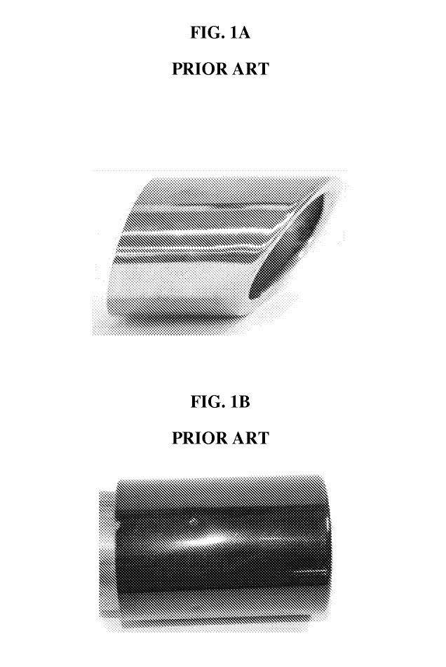

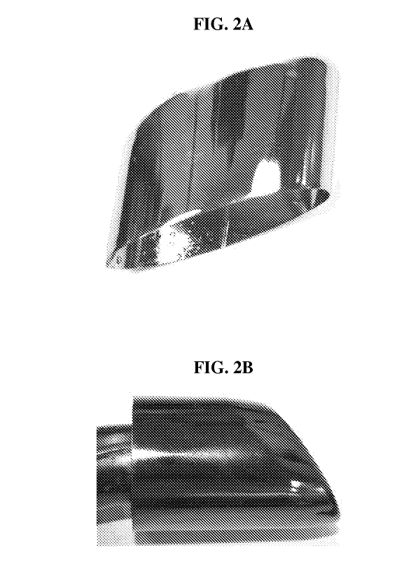

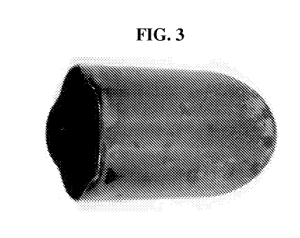

Reference numerals set forth in the FIGS. 1-8 include reference to the following elements as further discussed below:
100: Trivalent Dark Chrome Plating Layer
200: Organic-Inorganic Hybrid Coating Layer

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereafter, exemplary embodiments of the present disclosure will now be described in detail with reference to the accompanying tables and drawings.

The disclosure may, however, be exemplified in many different forms and should not be construed as being limited to the exemplary embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

In one aspect, the present invention provides a surface layer for a vehicle part. Particularly, a chemical bond may be formed between a trivalent dark chrome plating layer and an organic-inorganic hybrid coating layer in which an inorganinanoceramic oxide is included in an organic synthetic resin base.

In an exemplary embodiment, the surface layer for a vehicle part may include: a trivalent dark chrome plating layer; and an organic-inorganic hybrid coating layer forming a chemical bond with the plating layer. In the organic-inorganic hybrid coating layer, an inorganic nanoceramic oxide is included in an organic synthetic resin base.

As used herein, the term “trivalent dark chrome” refers to a dark colored chrome plating which may be obtained by adding impurities to trivalent chrome plating. As used herein, the term “surface layer” refers to a coating layer or plating layer formed on the surface of a substrate or a vehicle part, or combinations thereof.

Typically, since the hexavalent chrome plating has substantially low surface roughness, adhesion with typical organic coating materials may be substantially low. Further, since the common hexavalent chrome plating is mostly consisting of pure chromium (Cr), sufficient adhesion may not be obtained when the hexavalent chrome plating is cured as an organic-inorganic hybrid coating material.

In certain exemplary embodiments, the trivalent dark chrome plating layer according to an exemplary embodiment of the present invention includes Cr as a base, and may contain an impurity ion (M′). The impurity ion may be, but not limited to, Zn, Al, Mg, Si, C, S, Co, Fe, P or combinations thereof. As used herein, the term “impurity ion” refers to an ionic metal or metal element which can be an ion under certain condition in a Cr based layer composition. The impurity ion may provide an additional characteristic to the Cr based composition in a substantially low amount, but not limited to the amount included therein. The impurity ion may form a chemical bond with other ions or atoms in the composition or on the surface of the Cr based layer.

In yet certain exemplary embodiments, the inorganic nanoceramic oxide may include an ceramic ion. The ceramic ion may be, but not limited to, Si, Ti or Zr. As used herein, the term “ceramic ion” refers to an ionic metal or metal element included in the inorganic ceramic substance. The ceramic ion may provide an additional characteristic to the ceramic substance by chemically reacting or forming a bond with other ions or atoms in the composition thereof or on the surface of the ceramic substance.

In still certain exemplary embodiments, the chemical bond may be formed, particularly a M′-O-M bond between the impurity ion (M′) and the ceramic ion (M) may be formed. The chemical bond may be, but not limited to, a covalent bond.

In certain exemplary embodiments, the synthetic resin may be, but not limited to, an acrylic resin.

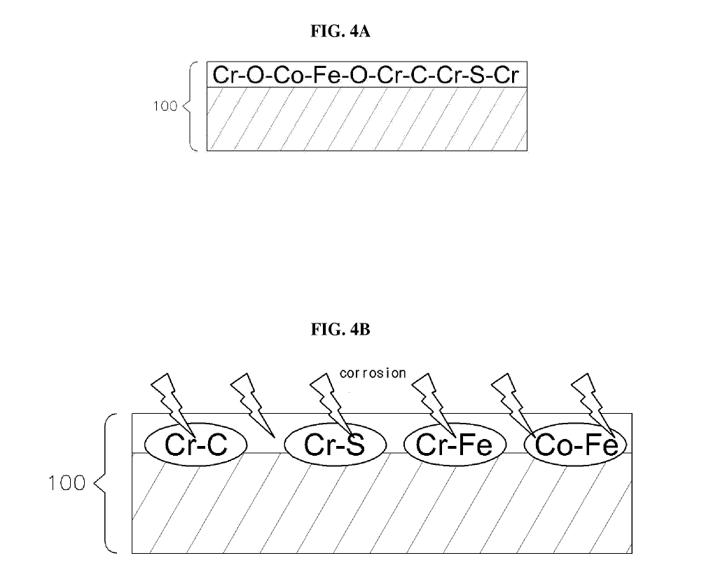

FIG. 4A prospectively illustrates an exemplary trivalent dark chrome plating layer at substantially low temperatures or at room temperature. FIG. 4B perspectively illustrates an exemplary trivalent dark chrome plating layer at high-temperature environments, for example, at a temperature of about 200° C. In the high-temperature environment, impurities such as C, Co, Fe and S included in the trivalent dark chrome plating layer (100) may chemically react with Cr to form a metal compound, thereby forming locally irregular regions on the surface. As such, corrosion resistance may deteriorate in such regions.

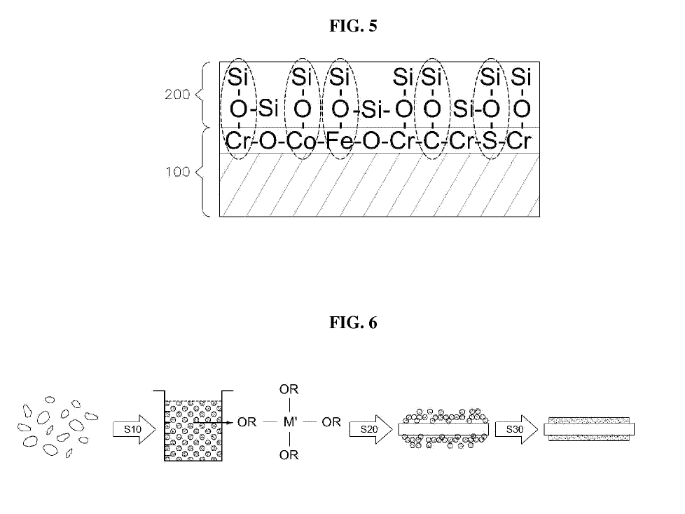

FIG. 5 is a perspective view showing a surface layer according to an exemplary embodiment of the present invention. As illustrated in FIG. 5, the adhesion may be strengthened by forming a strong chemical bond between the impurity ion (M′) included in the trivalent dark chrome plating layer (100) and the ceramic ion (M) included in the organic-inorganic hybrid coating layer (200). Accordingly, due to this chemical bond, both thermal resistance and corrosion resistance may be improved. Particularly, the formation of a metallic compound, which causes deterioration of corrosion resistance and is formed by the chemical reaction between Cr and other impurities, may be prevented even when the surface layer is exposed to high-temperature environments.

In the related art, adding a substantial amount of the impurities and obtaining darker-colored trivalent dark chrome have not been achieved due to deterioration in corrosion resistance. However, according to various exemplary embodiments of the present invention, the increase in the impurity content in the surface layer may lead to the increase in the chemical bonding with the coating layer, thereby improving adhesion property. In addition, the corrosion resistance may be improved. Consequently, various colors of trivalent chrome plating may be obtained.

In another aspect, the present invention relates to a method of manufacturing the surface layer for vehicle parts as described above.

FIG. 6 is a flowchart schematically showing an exemplary method of manufacturing an exemplary surface layer according to an exemplary embodiment of the present invention.

In certain exemplary embodiments, although it is not included in FIG. 6, a trivalent dark chrome plating layer may be applied on a surface of a substrate or a vehicle part. The trivalent dark chrome plating layer may be directly plated on the surface of the substrate or the vehicle part. In other certain exemplary embodiments, an additional plating layer, such as a copper plating layer or a nickel plating layer may be formed between the substrate or the trivalent dark chrome plating layer, without limitation.

In certain exemplary embodiments, in the step of S10, ceramic particles with an average diameter of about 10 to 50 nm may be dispersed in a liquid organic coating material, and subsequently, an organic-inorganic composite coating solution may be prepared, but not limited to, through a sol-gel process.

As used herein, the sol-gel process refers to a reaction inducing flocculation and coagulation of colloidal particles in a gel state. In certain exemplary embodiments, the sol-gel process may occur as hydrolysis and aqueous condensation reactions by dispersing inorganic nano-sized ceramic fine particle components and the like in the liquid organic coating material, thereby converting a sol state into a gel state.

### [Hydrolysis]

M′(OR)x+xH₂O ->M′(OH)ₓ+xROH

### [Aqueous Condensation]

M′(OH)+(HO)M->M′-O-M′+H₂O

In certain exemplary embodiment, in the step of S20, the surface layer may be formed by applying the coating solution on the surface of the trivalent dark chrome plating layer (S20). The method of applying the coating solution may be, but not limited to, a spray process or dipping process.

Subsequently, in the step of S30, the chemical bonding through an M′-O-M bond between an impurity ion (M′) and a ceramic ion (M) may be formed by curing the surface layer. In certain exemplary embodiments, the curing may be carried out for about 15 to 30 minutes at a temperature of about 160 to 200° C.

The photographic views showing the results after the heat treatment at 200° C. and evaluating the thermal resistance and corrosion resistance in cyclic corrosive environments are compared below.

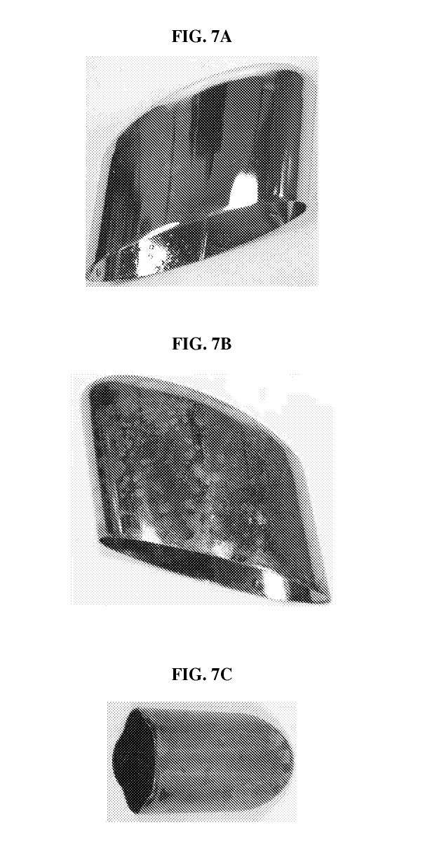

FIG. 7A shows an exemplary muffler tail trim in the related art which is applied with hexavalent white chrome plating. As shown, no discoloration occurred.

FIGS. 7B and 7C, respectively, show exemplary muffler tail trims in the related art which are applied with trivalent white chrome plating and trivalent dark chrome plating. As shown respectively, those muffler tail trims were discolored at an early stage and stained.

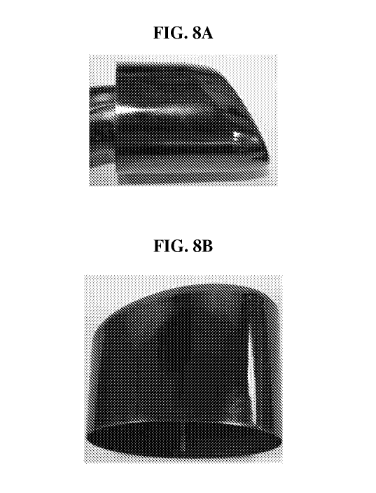

FIGS. 8A and 8B, respectively, show exemplary muffler tail trim formed with the surface layer according to an exemplary embodiment of the present invention. In FIG. 8A, clear color is coated, and in FIG. 8B, black color is coated. As consequence, no discoloration or stains occurred.

TABLE 1

| | Quality | | | | Water- | Salt | | |
|---|---|---|---|---|---|---|---|---|
| | of | | | Adhesive | resistant | Water | Impact | Acid |
| Category | Appearance | Hardness | Thickness | Property | Adhesion | Resistance | Resistance | Resistance |
| Evaluation | Black | 3-4 H | 6-10 μm | Cross-cut | 40° C./ | 480 Hr | 500 g- | 0.5% |
| Condition | (Blue/ | | | | 480 | (200° C. | 20 cm | Sulfuric |
| | Brown | | | | Hours | Thermal | | Acid |
| | | | | | | Shock) | | 24 Hours |

| | | | | | | | |
|---|---|---|---|---|---|---|---|
| Note | Favorable | Favorable | Favorable | Favorable | Favorable | Favorable | Favorable |

TABLE 2

| | | | | Thermal | | |
|---|---|---|---|---|---|---|
| | | | | Resistance | | |
| | Accelerated | | Thermal | and | | |
| | Weathering | Thermal | Cycling | Corrosion | Acid | Thermal |
| Category | Test | Resistance | Resistance | Resistance | Resistance | Shock |
| Evaluation | WOM 500 | 200° C./10 | 200° C. 10 | CCT-A 50 | 5% | 80° C./ |
| Condition | Hours | Hours | minutes/Air | cycle | Sulfuric | -30° C. |
| | | | Cooling 20 | (200° C. | Acid | 30 minutes × |
| | | | minutes × | Thermal | Solution | 70 times each |
| | | | 20 times | Shock) | Dipping/ | |
| | | | | | 24 Hours | |
| Note | Favorable | Favorable | Favorable | Favorable | Favorable | Favorable |

Table 1 shows the results of evaluating the coating properties of the muffler tail trim in which the surface layer according to the exemplary embodiment of the present invention is applied, and Table 2 shows the durability evaluation results of the muffler tail trim in which the surface layer according to an exemplary embodiment of the present invention is applied. As shown in Tables 1-2, improvements in all physical property such as corrosion resistance and thermal resistance may be obtained.

As set forth above, according to various exemplary embodiments of the present disclosure, sophisticated appearances and improved merchantability may be obtained by applying trivalent dark chrome to vehicle parts such as a muffler tail trim.

In addition, various colors of trivalent chrome plating may be obtained by applying organic-inorganic hybrid coating, and particularly by applying organic-inorganic hybrid coating of various color senses to single-colored trivalent dark chrome. Therefore, the coated trivalent chrome may be utilized in decorative surface treatments for vehicle interior and exterior parts.

Furthermore, the coating adhesion may also be improved by the M′-O-M bond between the impurity ion (M′) and the ceramic ion (M).

What is claimed is:

1. A surface layer for vehicle part comprising:
a trivalent dark chrome plating layer; and
an organic-inorganic hybrid coating layer forming a chemical bond with the plating layer
wherein, in the organic-inorganic hybrid coating layer, an inorganic nanoceramic oxide, is included in an organic synthetic resin base.

2. The surface layer for vehicle part of claim 1, wherein the trivalent dark chrome plating layer is a Cr-based plating layer containing an impurity ion (M′), wherein the impurity ion is Zn, Al, Mg, Si, C, S, Co, Fe, P or a combination thereof.

3. The surface layer for vehicle part of claim 1, wherein the inorganic nanoceramic oxide includes a ceramic ion (M), wherein the ceramic ion is Si, Ti or Zr.

4. The surface layer for vehicle components of claim 1, wherein the chemical bond is an M′—O—M bond of the impurity ion (M′) and the ceramic ion (M).

5. The surface layer for vehicle components of claim 1, wherein the synthetic resin is an acrylic resin.

6. A method of manufacturing a surface layer for a vehicle part, the method comprising:
applying a trivalent dart chrome plating layer on a substrate;
preparing an organic-inorganic composite coating solution through a sol-gel process by dispersing ceramic particles in a liquid organic coating material;
forming a surface layer by applying the coating solution on a surface of the trivalent dark chrome plating layer; and
curing the surface layer.

7. The method for manufacturing a surface layer for a vehicle part of claim 6, wherein an average diameter of the ceramic particles ranges from about 10 to about 50 nm.

8. The method for manufacturing a surface layer for a vehicle part of claim 6, wherein the coating solution is applied on the surface of the trivalent dark chrome plating layer using a spray or dipping process.

9. The method for manufacturing a surface layer for a vehicle part of claim 6, wherein the curing is carried out for about 15 to about 30 minutes at a temperature of about 160 to about 200° C.

10. The method for manufacturing a surface layer for a vehicle part of claim 6, wherein the substrate is a vehicle part.

11. A vehicle part treated with the surface layer of claim 1.
